(19) United States
(12) Patent Application Publication
(10) Pub. No.: US 2023/0170549 A1
(43) Pub. Date: Jun. 1, 2023

(54) BATTERY CELL CONNECTION ELEMENT, BATTERY CELL CONNECTION MODULE, BATTERY CELL CONNECTOIN ASSEMBLY AND METHOD FOR CONTROLLING THE TEMPERATURE OF AND ELECTRICALLY CONTACTING BATTERY CELLS

(71) Applicant: Witzenmann GmbH, Pfrozheim (DE)

(72) Inventors: David EHRENBERGER, Königsbach-Stein (DE); Alexander LEIPPI, Pforzheim (DE)

(73) Assignee: Witzenmann GmbH, Pfrorzheim (DE)

(21) Appl. No.: 18/012,443

(22) PCT Filed: Jun. 9, 2021
(86) PCT No.: PCT/EP2021/065464

§ 371 Date: Dec. 22, 2022

(30) Foreign Application Priority Data
Jun. 24, 2020 (DE) 10 2020 116 654.0

(51) Int. Cl. H01M 10/6556; H01M 50/30; H01M 10/42; H01M 50/204; H01M 50/183; H01M 50/507

(52) U.S. Cl. CPC H01M 10/6556; H01M 50/30; H01M 10/425; H01M 50/204; H01M 50/183; H01M 50/507

(57) ABSTRACT

A battery cell connection element (4) including a main body (44) formed as a fluid line element made of an electrically conductive material with a longitudinal axis (L). The main body (44) is preferably closed at both ends (4a, 4b), in particular in a fluid-tight manner, and has a peripherally, substantially closed casing wall, in which at least two through-openings (4da, 4ea), preferably punch-outs, are arranged on the same side of the main body (44), with these through-openings (4da, 4ea) being arranged adjacent to one another and offset in the direction of the longitudinal axis (L), in order to be able to connect the battery cell connection element (4) to cell arresters (3) of battery cells of a battery cell assembly via the through-openings (4da, 4ea).

### TECHNICAL FIELD

The invention relates to a battery cell connection element.

Furthermore, the invention relates to a battery cell connection module.

The invention also relates to a battery cell connection assembly comprising at least two battery cell connection elements according to the invention and at least one battery cell connection module according to the invention.

Additionally, the invention relates to a battery cell assembly comprising a plurality of battery cells and comprising a battery cell assembly according to the invention.

Lastly, the invention also relates to a method for controlling the temperature of and electrically contacting battery cells of a battery cell assembly.

In particular, the battery cell connection module and the battery cell connection element are also referred to hereinafter, for short, simply as the “connection module” and the “connection element,” respectively.

### BACKGROUND

Electromobility is becoming increasingly important in today's industrial development. In order to be able to provide the corresponding electrical energy, for example to operate a traction motor in an automobile, multiple battery cells are required which provide the corresponding electrical energy. It is regularly necessary here to connect said battery cells electrically conductively to form larger battery cell assemblies. At the same time, said battery cells heat up significantly, especially during their operation, so that it is also necessary to control the temperature of or cool the battery cells of a battery cell assembly. There is thus a need for a way of connecting battery cells of the type mentioned both electrically conductively and thermally effectively.

In order to utilize existing synergy effects, it has already been proposed in the past to realize the electrical contacting of the battery cells and their temperature control via an assembly of at least partially electrically conductive fluid line elements. A corresponding approach is described, for example, in DE 10 2018 109 421 A1 from the applicant.

However, the concepts developed so far in this context have proved to have scope for improvement in respect of their practical implementation, in particular because they require a relatively large number of manufacturing steps, which makes the corresponding production processes time-consuming and costly.

### SUMMARY

The object of the invention is to remedy this situation and provide a battery cell connection element, a battery cell connection module, a battery cell connection assembly, a battery cell assembly, and a method for controlling the temperature of and electrically contacting battery cells of a battery cell assembly, with which the above-mentioned disadvantages can be avoided in order to thus achieve a more time-efficient and more cost-effective production of electrical energy storage devices, in particular for automobiles.

The object is achieved in accordance with the invention by a battery cell connection element having one or more of the features described herein, by a battery cell connection module having one or more of the features described herein, by a battery cell connection assembly having one or more of the features described herein, by a battery cell assembly having one or more of the features described herein, and by a method for controlling the temperature of and electrically contacting battery cells having one or more of the features described herein.

Advantageous developments of the idea according to the invention are defined below and in the claims.

According to the invention, a battery cell connection element comprises a main body formed as a fluid line element made of an electrically conductive material with a longitudinal axis, which main body is closed fluid-tightly at its two ends and has a peripherally substantially closed casing wall, in which casing wall at least two through-openings, preferably punch-outs, are arranged on a same side of the main body, said through-openings being arranged next to one another and offset in the direction of the longitudinal axis.

An alternative embodiment of the battery cell connection element comprises a main body formed as a fluid line element made of an electrically conductive material having a longitudinal axis, which main body is open at both ends thereof and has a peripherally substantially closed casing wall.

A combination of both embodiments of the battery cell connection element with open ends and the mentioned through-openings is also possible: the through-openings are used for inserting a (welding) tool for attachment of the connection elements to electrical arresters of the battery cells (for further details see below) and can be closed (by means of suitable stoppers) after assembly has been completed.

A battery cell connection module according to the invention comprises at least two receptacles, which receptacles are designed to receive a battery cell connection element in a form-fitting and/or frictionally engaged manner in each case, and a fluid line portion, which fluid line portion has a fluid supply line and a fluid discharge line, in which at least the fluid line portion is formed in an electrically non-conductive material, preferably plastic, and in which the fluid supply line and the fluid discharge line are arranged relative to the receptacles in such a way that the fluid supply line is in fluidic connection with one receptacle and the fluid discharge line is in fluidic connection with the other receptacle.

A battery cell connection assembly according to the invention comprises at least one first battery cell connection element, at least one second battery cell connection element and at least one battery cell connection module, wherein the first battery cell connection element and the second battery cell connection element are each arranged in a corresponding receptacle, so that, on the one hand, the first battery cell connection element via one of its through-openings is in fluidic connection with the fluid supply line and, on the other hand, the fluid discharge line is in fluidic connection with one of the through-openings of the second battery cell connection element, or so that the two battery cell connection elements are in fluidic connection with one another via one of their through-openings and via the fluid line portion, wherein in any case the two battery cell connection elements are spaced apart from one another so that there is no electrically conductive connection between the connection elements.

When the alternative embodiment of the battery cell connection element is employed, a correspondingly adapted alternative battery cell connection assembly comprises at least one first (alternative) battery cell connection element, at least one second (alternative) battery cell connection element and at least one battery cell connection module, wherein the first (alternative) battery cell connection element and the second (alternative) battery cell connection element are each arranged in a corresponding receptacle, so that, on the one hand, the first (alternative) battery cell connection element via one of its open ends is in fluidic connection with the fluid supply line and, on the other hand, the fluid discharge line is in fluidic connection with one of the open ends of the second battery cell connection element, or so that the two (alternative) battery cell connection elements are in fluidic connection with one another via one of their open ends in each case and via the fluid line portion, wherein in any case the two (alternative) battery cell connection elements are spaced apart from one another by the interposed fluid line portion so that there is no electrically conductive connection between the (alternative) connection elements.

A battery cell assembly according to the invention comprises a plurality of battery cells and a battery cell connection assembly, in particular an alternative battery cell connection assembly, wherein the individual battery cells each have a first cell arrester with a first electrical polarity and a second cell arrester with a second electrical polarity, in which the first cell arrester of one battery cell is electrically conductively connected to the second cell arrester of another battery cell via a, in particular alternative, battery cell connection element, and in which the first, in particular alternative, battery cell connection element is fluidically connected to the second, in particular alternative, battery cell connection element via the fluid line portion of the battery cell connection module.

A method according to the invention for controlling the temperature of and electrically contacting battery cells of a battery cell assembly includes:
a) providing at least two, in particular alternative, battery cell connection elements;
b) providing at least one battery cell connection module;
c) arranging the battery cell connection elements in the battery cell connection module to create a, in particular alternative, battery cell connection assembly;
d) producing the battery cell assembly by attaching the, in particular alternative, battery cell connection assembly to an assembly of battery cells and electrically conductively connecting the, in particular alternative, battery cell connection elements to the cell arresters, in particular in an integrally bonded manner;
e) passing a temperature control fluid through the, in particular alternative, battery cell connection elements and the fluid line portion or fluid line portions; and
f) electrically contacting the battery cells via the, in particular alternative, battery cell connection elements.

The starting point of the present invention is therefore the above-defined, in particular alternative, battery cell connection element, which can function both as an electrical connector and as a fluid line element and is accordingly suitable for conducting a temperature control fluid for a battery cell assembly. Due to the design of its main body made of an electrically conductive material, the battery cell connection element according to the invention can be used for connecting electrical terminals (of different polarity) in a battery cell assembly. However, the invention also comprises battery cell connection elements in which the entire main body is not made of an electrically conductive material, but only parts thereof. The two through-openings allow the battery cell connection element to be connected (in an integrally bonded manner) to said electrical terminals of a battery cell assembly in a simple manner, because a tool to be used accordingly can be inserted through the through-openings. In the alternative embodiment, the battery cell connection element is preferably connected (in an integrally bonded manner) to said electrical terminals of a battery cell assembly by means of a fillet weld between an (outer) wall of the connection element and said electrical terminals.

In this way, the battery cell connection element according to the invention can be used to construct battery cell assemblies in a simple and cost-effective way. This will be discussed in greater detail further below.

Advantageously, the battery cell connection element according to the invention, in its two alternatives, can be used together with a battery cell connection module according to the invention, which battery cell connection module has receptacles for receiving battery cell connection elements according to the invention. In this way, the cooperation of the battery cell connection element and the battery cell connection module makes it possible to create a battery cell connection assembly according to the invention, which makes it possible to produce battery cell assemblies according to the invention in a particularly simple and convenient manner. This will also be discussed in greater detail further below. Within the scope of the present invention, it is possible in this way, by bringing together (at least two) battery cell connection elements according to the invention and at least one battery cell connection module according to the invention, to create a preconfigured battery cell connection assembly according to the invention, through the use of which battery cell assemblies which can be electrically contacted and thermally temperature-controlled can be produced in a particularly simple manner.

In this way, the present invention also provides a method according to the invention for controlling the temperature of and electrically contacting battery cells of a battery cell assembly, which method is based on the use, described above, of (at least two) battery cell connection elements according to the invention and a battery cell connection module according to the invention, which together form a battery cell connection assembly according to the invention.

The developments of the battery cell connection element according to the invention described below also apply to its alternative embodiment, insofar as they do not relate specifically to the through-openings as such or to the ends sealed fluid-tightly.

A first development of the battery cell connection element according to the invention provides that the main body is substantially planar in portions, at least on its side opposite the through-openings, so that preferably planar portions of the main body are aligned with the through-openings in a direction transverse to the longitudinal axis, in which most preferably the main body has two side walls which are substantially planar in portions, are arranged parallel to one another, and in one of which the through-openings are arranged. Extremely preferably, the other opposite side wall has a counter contour (complementary contour) of a battery cell arrester in order to be able to connect the battery cell connection element to the battery cell arrester as well as possible.

If the main body, as described, is substantially planar in portions on its side opposite the through-openings or even without such through-openings, wherein the term “substantially” is intended to include usual manufacturing tolerances, the battery cell connection element can be connected particularly simply and reliably in a planar manner to battery cell arresters or terminal poles which are also substantially planar. If said planar portions of the main body are aligned with the through-openings in a direction transverse to the longitudinal axis, a geometrically advantageous configuration is created, because in (previously known) battery cell assemblies the cell arresters of adjacent battery cells are generally arranged on a line next to one another.

Another development of the battery cell connection element according to the invention provides that the main body, at least with the exception of its (closed) ends, has an oval cross-section. Such an embodiment has proven to be particularly favorable in terms of manufacturing technology and also with regard to the required installation space. Advantageously, the oval cross-section is created by forming a central rectangular cross-section with attached semicircles and accordingly has the shape of a “stadium oval”. However, the invention is by no means limited to such cross-sections of the main body.

In yet another development of the battery cell connection element according to the invention, it can be provided that the main body is flattened and/or folded at its ends and thus closed. In addition, the main body can be closed at its ends in an integrally bonded manner, in particular by welding or soldering. This also results in a particularly simple manner in a battery cell connection element which can be advantageously used within the scope of the present invention in the manner of a fluid line element closed at the ends.

In order to be able to compensate in particular for manufacturing tolerances, dimensional tolerances and thermal geometrical changes, an extremely preferred development of the battery cell connection element according to the invention provides that the main body has two substantially identical halves along its longitudinal axis, between which a central portion of modified shape is arranged, which central portion preferably has at least one peripheral bellows corrugation, most preferably a plurality of such bellows corrugations, and is preferably formed integrally with the rest of the main body.

Such bellows corrugations or ring corrugations are known to a person skilled in the art and have been used for decades in flexible metal hoses to absorb, in particular, thermally induced movements and deformations.

Yet another development of the battery cell connection element according to the invention provides that the through-openings have a clear opening cross-section suitable for insertion of a tool, preferably a welding tool, preferably a clear opening cross-section of about 5 mm to about 30 mm. It has already been noted that the mentioned through-openings can advantageously be used to insert a tool into the battery cell connection element in order to connect the latter to a cell arrester of a battery cell (in an integrally bonded manner). As the applicant has found out, the dimensions given above are particularly suitable in this context.

A first development of the battery cell connection module according to the invention provides that it comprises a first number of more than two receptacles and a second number of more than one fluid line portion. Each fluid line portion always connects at least two receptacles to one another fluidically.

While in the context of the present invention the battery cell connection elements described above can also provide for the electrically conductive connection of two battery-cell cell arresters in addition to their fluid line function, the battery cell connection module according to the invention with its fluid line portion serves to connect two battery cell connection elements to one another fluidically, wherein due to the fact that at least the fluid line portion is made of an electrically non-conductive material it is ensured at the same time that battery-cell cell arresters are not unintentionally connected to one another electrically conductively, which could lead to a short circuit. In this way, it is possible to separate the electrical contacting of the battery cells from their temperature control.

As a rule, battery cells are arranged adjacently in such a way that the arrangement of the electrical poles of two directly adjacent battery cells is reversed in each case. For example, a positive pole of a first battery cell is located next to the negative pole of another battery cell, and vice versa. With the aid of a battery cell connection element according to the invention, two such adjacent terminals of different polarity can be connected to one another electrically conductively in order to be able to connect a plurality of battery cells in series in this way. Through the interaction of a battery cell connection element according to the invention with a battery cell connection module according to the invention, it is now possible to continue the fluid line function ensured by the battery cell connection element via the battery cell connection module and its fluid line portion to a further, directly adjacent cell arrester in the event of electrical separation. In this way, the series connection of the battery cells described above can be achieved without an electrical short circuit occurring.

If the battery cell connection element is equipped with open ends, an electrically non-conductive line element, preferably made of plastic, can be introduced (inserted or pushed) into the battery cell connection elements to conduct fluid from connection element to connection element. This also makes it possible to continue the fluid line function ensured by the battery cell connection element via the line element to a further, directly adjacent cell arrester in the event of electrical isolation. In this way, it is also possible—in the course of an alternative process—to achieve the series connection of the battery cells described above together with temperature control without an electrical short circuit occurring. The line element can pass through and fluidically connect a plurality of connection elements connected in series.

If the battery cell connection element has through-openings of the type mentioned, the line element can have corresponding through-openings. The through-openings of the connection element and the line element, which are aligned in the assembled state, can then be sealed jointly fluid-tightly with a stopper or closure part in each case.

The battery cell connection element and the line element can be connected to one another in an integrally bonded manner. For this purpose, in particular, at least one adhesive corrugation or the like (i.e., a defined structure for receiving adhesive as a connecting and sealing agent) can be provided on the connection element and is preferably filled with adhesive from the outside via an opening before the line element is inserted or afterwards. Alternatively or additionally, at least one adhesive groove or adhesive channel can be provided on the line element and serves substantially for the same purpose.

The line element can be enlarged in cross-section (“inflated” or otherwise outwardly reshaped) after its insertion into a battery cell connection element or a plurality of battery cell connection elements in order to line the battery cell connection element(s) in a frictionally engaged or form-fitting manner.

The first development, already mentioned above, of the battery cell connection module according to the invention provides that a larger number of battery cells can also be connected to form a correspondingly large battery cell assembly.

Yet another development of the battery cell connection module according to the invention provides that the fluid line portions and/or the receptacles each run in or parallel to a common plane and/or are arranged distributed over the periphery of a rectangle. In this way, an assembly formed of the battery cell connection elements according to the invention and the battery cell connection module according to the invention is obtained which is suitable in a particularly simple manner for later use with an assembly of battery cells in order to connect them to one another in the manner mentioned further above.

Yet another development of the battery cell connection module according to the invention is that a first fluid line portion has a supply line for a temperature control fluid to the first fluid line portion and a second fluid line portion has a discharge line for a temperature control fluid from the second fluid line portion. In this way, the battery cell connection module can be connected to an external temperature control or cooling circuit via the supply line or can adjoin such a circuit. The temperature control fluid then returns to this external circuit via said discharge line.

Yet another development of the battery cell connection module according to the invention provides that the fluid line portion or the fluid line portions are open on a first side of the battery cell connection module and in which the receptacles are arranged on a second side of the battery cell connection module facing away from the first side. In such an embodiment it is ensured that, even in the case of battery cell connection elements which are already received in the corresponding receptacles of the battery cell connection module, the through-openings, in the manner described further above, are still accessible from the outside via the fluid line portions which are open on one side, in order to connect the battery cell connection elements to the cell arresters (in an integrally bonded manner). In other words, the battery cell connection elements can first be inserted into the battery cell connection module, and then the connection of the battery cell connection elements to the cell arresters takes place. In this way, the handling of the battery cell connection elements in particular is greatly simplified.

This also applies analogously to the alternative embodiment of the battery cell connection elements, in which, however, no through-openings are provided, so that accessibility from the outside also plays a less significant role, as long as, in particular, the above-described method of connection (fillet welding) remains possible. The fluid line portion can simply be another (tube) line portion here, which is always arranged (interposed) between two open ends of different battery cell connection elements.

In order to nevertheless be able to ensure the aforementioned fluid line of the temperature control fluid via the battery cell connection elements and the battery cell connection module, an extremely preferred other development of the battery cell connection module provides that it additionally has at least one cover part, which cover part seals the at least one fluid line portion, preferably a plurality of fluid line portions, most preferably all fluid line portions, from the outside fluid-tightly. Advantageously, corresponding sealing elements can be arranged or integrally molded on the cover part or in a peripheral region of the fluid line portions for this purpose. The same also applies to the region of the fluid supply line and the fluid discharge line of the battery cell connection module, at which points the latter interacts with a battery cell connection element in the region of one of the through-openings concerned. In this way, fluid tightness is ensured in all cases. In the alternative embodiment of the battery cell connection elements, such a cover part is dispensable in principle.

In yet another development of the battery cell connection module according to the invention, this also has a further receptacle for receiving an electronic printed circuit board (PCB). Preferably, this further receptacle is surrounded by the receptacles for the battery cell connection elements and by the fluid line portions. In this way, the installation space regularly available in battery cell assemblies centrally above the battery cells can be used advantageously for the arrangement of an electronic printed circuit board in particular, because an (electrically conductive and/or fluidic) connection of the cell arresters is regularly required only in the edge regions of the battery cell assembly.

In addition, in a development of the battery cell connection module according to the invention, it can also be provided that galvanic connections start from the further receptacle and extend to the receptacles for the battery cell connection elements. In this way, it is easily possible to electrically conductively connect the electrical printed circuit board received in the further receptacle to the battery cell connection elements.

This may be necessary or advantageous, for example, if the electronic printed circuit board is intended to form a battery management system (BMS). In this context, it may be necessary, for example, to determine and/or equalize a potential of the individual battery cells. For this purpose, the mentioned galvanic connections can be used, because a complex, additional wiring of the battery cell assembly to the BMS (of the electronic printed circuit board) is unnecessary.

A further embodiment of the connection to the electronic printed circuit board can be realized by printing (for example by means of screen printing or pad printing) conductive tracks onto the battery cell connection module. This then eliminates the need for complex galvanic connection structures and makes the component lighter and more cost-effective. Contacting can be ensured via mechanically prestressed spring elements.

A first development of the battery cell connection assembly according to the invention provides that the battery cell connection elements and the fluid line portions jointly form a closed fluid circuit. If necessary, this closed fluid circuit can be closed off to the outside by the cover part mentioned further above. The phrase “closed fluid circuit” expressly includes the presence of the supply line and discharge line for the temperature control fluid mentioned further above.

Yet another development of the battery cell connection assembly according to the invention provides that the battery cell connection elements are accessible from the first side via the fluid supply line or the fluid discharge line and from the outside via the respective through-openings, if necessary with the cover part removed. In this way, it is again ensured that the use of a battery cell connection assembly according to the invention of a corresponding development allows a subsequent (integrally bonded) connection of the individual battery cell connection elements from said first side to the cell arresters of a battery cell assembly. This facilitates the handling of said elements, which has already been noted.

Yet another development of the battery cell connection assembly according to the invention provides that an electronic printed circuit board is received in said further receptacle, which electronic printed circuit board preferably comprises electronic components for controlling the operation of a battery cell assembly formed of a plurality of battery cells. This has already been referred to further above.

In order to avoid, in particular, time-consuming and costly subsequent wiring or cabling of the electronic printed circuit board, yet another development of the battery cell connection assembly according to the invention provides that the electronic printed circuit board and/or at least some of the electronic components located thereon electrically contact the battery cell connection elements, or are in electrically conductive connection therewith, via said galvanic connections.

It has proven to be particularly advantageous for practical use if the battery cell connection elements are held form-fittingly and/or in a frictionally engaged manner on the battery cell connection module in the region of the receptacles. In particular, so-called latching, clamping or clip connections can be considered in this region, which can be formed particularly easily and inexpensively if the battery cell connection module is formed as an injection-molded part in a plastic. However, the invention is by no means limited to such an embodiment of the battery cell connection module.

Any sealing elements already mentioned can be directly integrally molded or cast on (2K injection molding) during the production of the battery cell connection module. The use of separate sealing elements can also be considered. This applies in particular to the transitions from the battery cell connection elements to the battery cell connection module and from the battery cell connection module to the cover part. Corresponding sealing elements can also be arranged on the cover part.

In a first development of the battery cell assembly according to the invention, it can be provided that the battery cell connection elements are connected to the cell arrester in an integrally bonded manner. This has already been noted repeatedly. Such a connection is particularly reliable and durable.

Yet another development of the battery cell assembly according to the invention provides that the battery cell connection elements and the fluid line portion or fluid line portions are filled with or passed through by a temperature control fluid (dielectric).

In this way, particularly efficient temperature control of the battery cells or cell arresters can be achieved.

Lastly, a development of the method according to the invention also provides that, in step d), the battery cell connection elements are connected, preferably welded, to the cell arresters from the outside through the fluid supply line or the fluid discharge line and via the respective through-openings, and in which subsequently, before step e), the cover part is fitted to close off the battery cell connection assembly and the relevant fluid flow paths.

In this way, the present invention makes it possible to convert the arrester cooling of cell arresters in a battery cell assembly into an arrester cooling module or to develop it further into such a module. Said (battery cell connection) module comprises, in accordance with the foregoing description, a frame-like main body which is preferably formed from injection molded plastic. The metal elements (the battery cell connection elements) for the electrical interconnection of the battery cells can be introduced into this main body and advantageously fixed by means of a clip or snap-action connection or the like. This results in an assembly/handling aid, as described above, which can ideally support the advantageously relatively thin-walled connection elements when they are (elastically) integrally molded onto the cell arresters. The mentioned main body made of an electrically non-conductive material (preferably plastic injection molding) additionally ensures the insulation of all components with an electrical potential that differs from one another.

It has already been pointed out that the (metal) connection elements can be produced directly from a semi-finished product (tube) by forming. For end-face sealing, the respective ends (tube ends) can be crimped and welded or soldered. Soldering in particular can also influence the material properties in a single process step.

The required fluid seal (for the temperature control fluid) can be realized by plugging in the metal connection elements and securing them to the connection module by means of an elastic form fit, in particular in the region of the through-openings.

Advantageously, the metal connection elements are made of a material that has good electrical and thermal conductivity, preferably an aluminum alloy or copper.

One variant provides for producing said main body of the battery cell connection module in a multi-component injection molding process and directly injection molding on (integrally molding on) the sealing elements required for sealing with respect to the connection elements, to which reference has already been made above.

In addition, within the scope of another development of the invention, it is proposed to notch out the connection elements above the battery poles (cell arresters) so that accessibility to the weld seam connection of the metal connection elements to the cell arrester is created. This has already been noted repeatedly further above (through-openings, punch-outs). Furthermore, the advantage of this approach is that the fluid channels for the temperature control fluid can be produced in a single assembly step in the z-direction. Said z-direction designates here a (vertical) direction transverse to a plane containing the cell arresters of a battery cell assembly. However, the invention is by no means limited to such a geometry, wherein in principle it is possible to form inlets and outlets for the temperature control fluid within or parallel to said plane.

Within the scope of another development of the invention, it is possible to attach the cover part for closing the fluid-carrying channels to the rest of the connection module via living hinges, so that the handling effort is reduced.

In a development of the method already described further above, it is within the scope of the present invention to first produce the connection module in a (2K) injection molding process and then to produce the metal connection elements and clip them into the connection module. Thereafter, the metal connection elements can be elastically integrally molded to the cell arresters of a battery cell assembly by being supported in/on the main body (of the connection module) while the latter is fastened to the battery cell assembly, for example clipped in place. Then, the electrical connections of the metal connection elements to the cell arresters are produced in a welding process, preferably in the z-direction. Subsequently, the fluid channels are closed by fitting the cover part. At the end of these method steps, a leak test can be carried out.

Deviating from the above description, a variant is possible in which a (metal) connection element forms a so-called module arrester. In other words: At least one of the metal connection elements can protrude (laterally) from the battery cell assembly and in this way can form said module arrester, i.e., an electrical connection for the entire battery cell assembly.

It has already been noted that certain galvanic connections can be provided, for example to integrate a BMS into the module main body of the connection module. In a development of this idea, embodiments are possible in which temperature measuring elements or other types of sensors are integrated directly into the main body of the connection module.

It has already been noted that the module main body is preferably made in a plastic. Specifically, in a development of this idea, it can be proposed to make the main body of the connection module from PP30GF or PA.

A multi-part variant can be provided, in which the main body of the connection module fixes the metal connection elements and an additional fluid line body, which is only attached to the battery cell assembly after the main body has been mounted, is used to close the fluid channels. In principle, this corresponds to the use of a cover part already mentioned further above.

In a development of this idea it can be provided that the fluid line body or bodies (cover part(s)) are sealed by means of a seal or an injection-molded-on sealing element in a mechanically prestressed manner, or that the sealing is effected by means of an adhesive connection, which in turn can be fixed by means of a clip connection or the like until the adhesive has completely crosslinked.

Channels for battery cell degassing can additionally be provided in the battery cell connection module. In this context, it is possible to map the mentioned channels in the plastic or to form them as additional (metal) inserts. Such an embodiment can advantageously allow a fluid access or outlet as well as the electrical contacting to be placed geometrically almost completely freely on the connection module.

### BRIEF DESCRIPTION OF THE DRAWINGS

The invention described above is distinguished by its lightweight construction properties, extensive functional integration, ease of assembly and handling, modular design, achievable electrical insulation, and the interface to the automotive industry thus created.

Further features and advantages of the invention will become apparent from the following description of exemplary embodiments with reference to the drawings.

FIG. 1 shows an isometric view of a battery cell assembly with battery cell connection elements arranged thereon;

FIG. 2 shows a detailed isometric view of a battery cell connection element;

FIG. 3A shows a first sectional view of the battery cell connection element from FIG. 2;

FIG. 3B shows a second sectional view of the battery cell connection element from FIG. 2;

FIG. 4 shows the battery cell assembly from FIG. 1 with a battery cell connection module according to the invention in an isometric view without cover part;

FIG. 5 shows the battery cell assembly from FIG. 4 with fitted cover part;

FIG. 6 shows a first section through the battery cell assembly according to FIG. 5 in detail;

FIG. 7 shows a second section through the battery cell assembly according to FIG. 5 in detail;

FIG. 8 shows an alternative embodiment of battery cell connection element and battery cell connection module;

FIG. 9 shows an alternative embodiment of a battery cell assembly in a perspective overall view;

FIG. 10 shows a partial longitudinal section through the embodiment according to FIG. 9;

FIG. 11 shows a partial cross-section through the embodiment according to FIG. 9; and

FIG. 12 shows a partial cross-section through an embodiment alternative to that shown in FIG. 9.

### DETAILED DESCRIPTION

In the following detailed description of the figures, like reference signs denote like or at least functionally like elements. For reasons of clarity, not all elements appearing in all figures are explicitly denoted. In some cases, therefore, in the description of these figures reference is made to other figures.

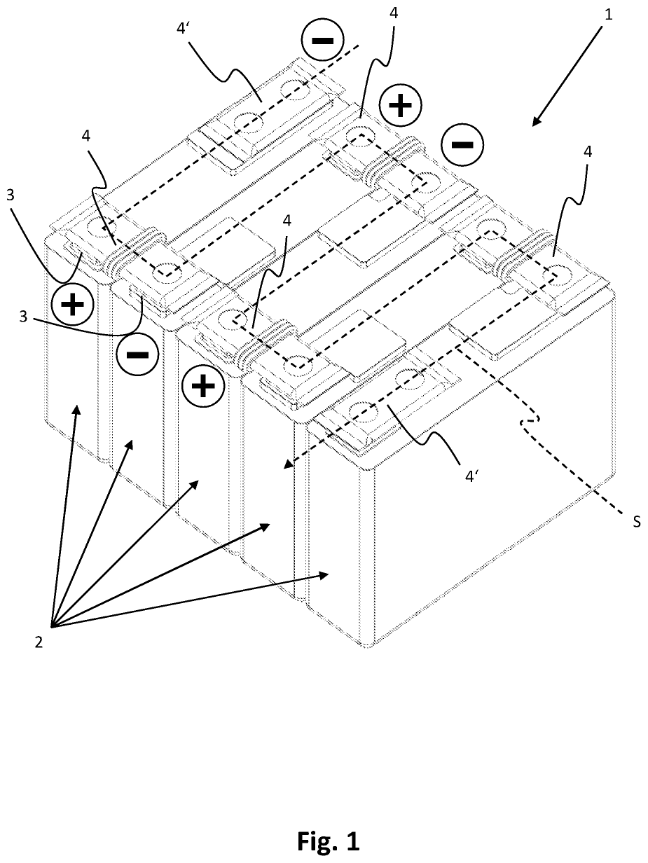

FIG. 1 shows an isometric overall view of an assembly of battery cells (battery cell assembly), which is provided in its entirety with the reference sign 1. Reference sign 2 denotes the individual battery cells, which are formed as so-called prismatic cells, without the invention being limited to this. Each of the battery cells 2 is arranged in an approximately cuboidal housing and has two so-called cell arresters 3 on its upper side, of which only two are explicitly denoted in FIG. 1. Each battery cell 2 has a cell arrester with a first electrical polarity (for example positive pole) and a second cell arrester with a second electrical polarity (for example negative pole). In FIG. 1, some of the battery cells 2 or cell arresters 3 are explicitly marked with corresponding symbols (+ and −, respectively).

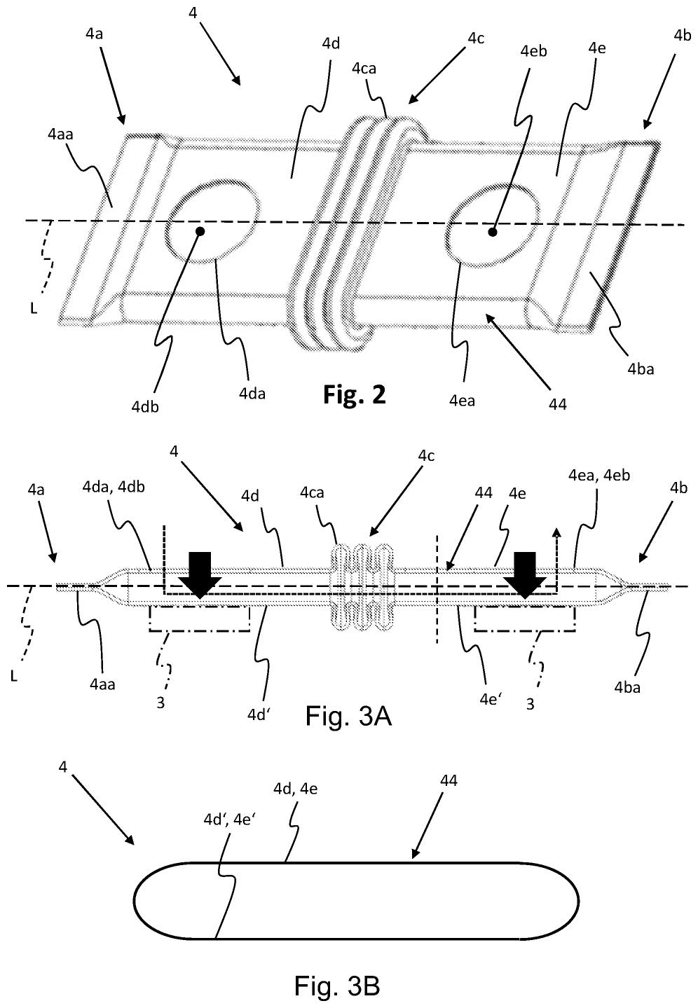

The battery cells 2 are electrically arranged in the manner of a series connection so that the voltages of the individual battery cells 2 add up to a larger total voltage. For this purpose, the battery cells 2 are arranged alternately with reversed electrical polarity, as shown. In other words, a cell arrester 3 with first polarity of a given battery cell 2 is arranged directly adjacent to the cell arrester 3 with second polarity of an adjacent battery cell 2, as shown. For reasons of clarity, not all cell arresters 3 are denoted with a corresponding electrical polarity in FIG. 1. The dashed meandering line in FIG. 1 symbolizes a current flow path or current flow S through the battery cell assembly 1. For this purpose, the cell arresters 3 of adjacent battery cells 2 with different polarity are each electrically conductively connected to a battery cell connection element 4. The precise design of the battery cell connection elements 4 will be discussed in greater detail hereinafter, in particular with reference to FIGS. 2, 3A and 3B.

In addition to the battery cell connection elements 4 already discussed, which each electrically connect different poles or electrically differently polarized cell arresters 3 of adjacent battery cells 2, there are also similarly designed battery cell connection elements 4′ in the embodiment according to FIG. 1, which are each electrically conductively connected to only one battery-cell cell arrester. According to the illustration in FIG. 1, these battery cell connection elements 4′ are located at the start and at the end of the current flow path S and can thus preferably be used as so-called module arresters for electrically connecting the battery cell assembly 1 to an external circuit. The battery cell connection elements 4′ differ from the previously discussed battery cell connection elements 4 fundamentally only in the absence of bellows corrugations in the central region of the battery cell connection elements. This will also be discussed in greater detail further below.

In the context of the present invention, the battery cell connection elements 4 not only serve to electrically connect adjacent battery cells 2, but they also still perform a fluid line function for a temperature control fluid for controlling the temperature of the battery cells 2. This aspect will also be discussed further below.

With regard to the subject of FIG. 1, it should also be noted that adjacent battery cell connection elements 4, 4′ do not touch one another, so that no electrically conductive contact is formed between them. Such contact could otherwise lead to a short circuit of the battery cell assembly 1 and to a destruction of the battery cells 2.

FIG. 2 shows a single battery cell connection element 4 according to FIG. 1 in greater detail. It comprises a main body 44 formed as a fluid line element (tube portion) made of an electrically conductive metal with a longitudinal axis L, which main body 44 is sealed fluid-tightly at its two ends 4a, 4b. The main body 44 has a peripherally substantially closed casing wall, in which casing wall at least two through-openings 4da, 4ea, preferably punch-outs, are arranged on a same side of the main body. The through-openings 4da, 4ea are arranged next to one another and offset in the direction of the longitudinal axis L.

In particular, the battery cell connection element 4 is formed substantially as a flat tubular element with a flat, oval cross-section in large regions, as can be seen in particular from FIG. 3B. At its end faces 4a, 4b, the battery cell connection element 4 is sealed fluid-tightly, for example folded or connected in an integrally bonded manner, for example soldered. These end faces of the battery cell connection element 4 are denoted in FIG. 2 by reference signs 4aa and 4ba. In its central region between the ends 4a, 4b, the battery cell connection element 4 has a corrugated portion 4c, in which a number of ring corrugations or bellows corrugations 4ca are formed. In the regions between each of its ends 4a, 4b and the corrugated region 4c, the battery cell connection element 4 is substantially planar and has parallel side surfaces (side walls) or casing surface portions (casing wall portions), only two of which are denoted by reference signs 4d and 4e in FIG. 2. In each of these planar casing surface portions 4d, 4e, a through-opening 4da, 4ea is formed, defining an opening 4db, 4eb communicating with an interior of the battery cell connection element 4. In particular, through each of the through-openings 4da, 4ea, the casing surface portion on the other side of the battery cell connection element 4, which is not further denoted in FIG. 2, can be reached or accessed from the outside. The bellows corrugations 4ca or the corrugated region 4c provide a certain elastic deformability of the battery cell connection element in the direction of its longitudinal axis L, as shown. For this reason, the battery cell connection elements 4 of the type shown in FIG. 2 are used according to FIG. 1 for connecting different battery cells 2 (cf. FIG. 1). FIG. 3A a shows a section through the battery cell connection element 4 of FIG. 2 along the longitudinal axis L. FIG. 3B shows a section transverse thereto, for example according to the dashed vertical line in FIG. 3A.

Accordingly, in the case of the battery cell connection element 4 shown, it is provided that the main body 44, at least on its side opposite the through-openings 4da, 4ea, is substantially planar in portions (for reference signs 4d′, 4e′; cf. FIGS. 3A, 3B), so that preferably planar portions of the main body 44 are aligned with the through-openings 4da, 4ea or the openings 4db, 4eb, respectively, in a direction transverse to the longitudinal axis L. Specifically, the main body 44 thus has at least two side walls 4d, 4d′ and 4e, 4e′, respectively, which are substantially planar in portions, are arranged parallel to one another, and in each of which the corresponding through-opening 4da, 4ea is arranged.

In FIG. 3A, the black block arrows symbolize the aforementioned accessibility of the lower side surfaces or side walls 4d′ and 4e′ via the through-openings 4da, 4ea and the openings 4db, 4eb, respectively. In this way, the battery cell connection element 4 can be connected to the underlying cell arresters 3 (shown in dash-dotted form in FIG. 3A) by means of a suitable tool (not shown), for example in an integrally bonded manner. The direction symbolized by the block arrows 3a generally corresponds to the z-direction. The dashed arrow in FIG. 3A symbolizes a possible flow path for the aforementioned temperature control fluid through the battery cell connection element 4. Without restriction, the temperature control fluid can flow into the battery cell connection element through the opening 4db and can leave it again via the opening 4eb, as shown. In this way, the battery cell connection element 4 can be used both to electrically conductively connect cell arresters 3 and to control their temperature, as will be discussed in greater detail further below. Preferably, for this purpose, the battery cell connection element 4 is made of a metal material which is a good electrical (and thermal) conductor, in particular copper or an aluminum alloy (without limitation).

FIG. 3B, to which reference has already been made, shows a cross-section through the battery cell connection element 4 approximately in accordance with the vertical dashed line in FIG. 3A. Accordingly, the battery cell connection element has a flat, oval cross-section in this region (and correspondingly also on the other side of the corrugated region 4c; cf. FIG. 3A), so that the side surfaces or casing wall portions 4d, 4e or 4d′, 4e′ already discussed are planar in said regions. This simplifies in particular the attachment of the battery cell connection element 4 to the cell arresters 3 (cf. FIG. 3A).

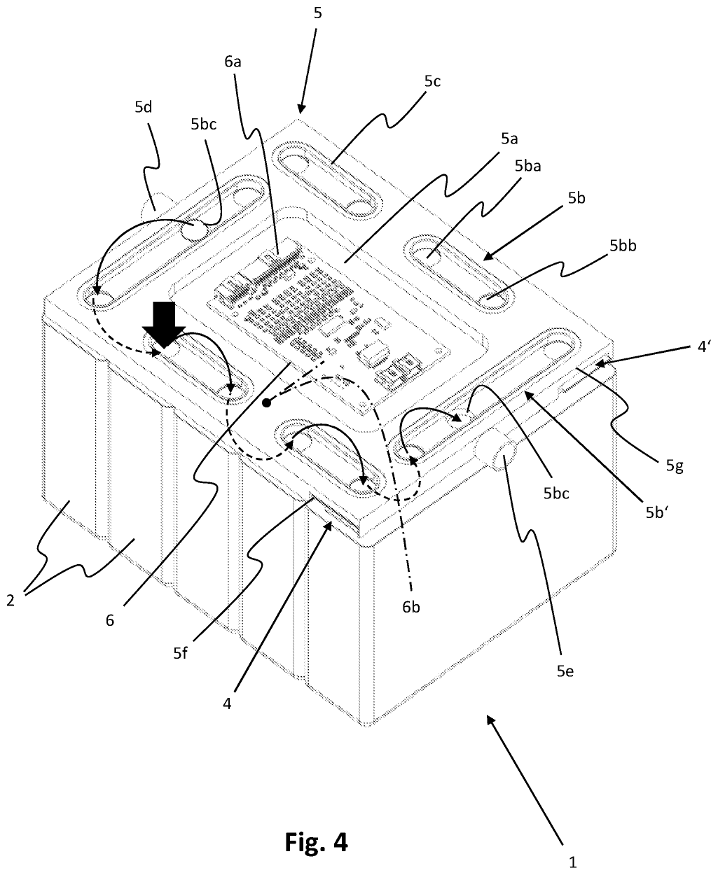

FIG. 4 shows a further isometric overall view of a battery cell assembly 1 comprising a plurality of battery cells 2 and battery cell connection elements 4, 4′ connected to the cell arresters of the battery cells 2 according to FIG. 1 and FIGS. 2 to 3B, respectively. However, in the representation in FIG. 4, said cell arresters and battery cell connection elements 4, 4′ are only partially visible, because a battery cell connection module 5 made of injection-molded plastic has been fitted from above onto the battery cell assembly 1 and correspondingly also onto said battery cell connection elements 4, 4′.

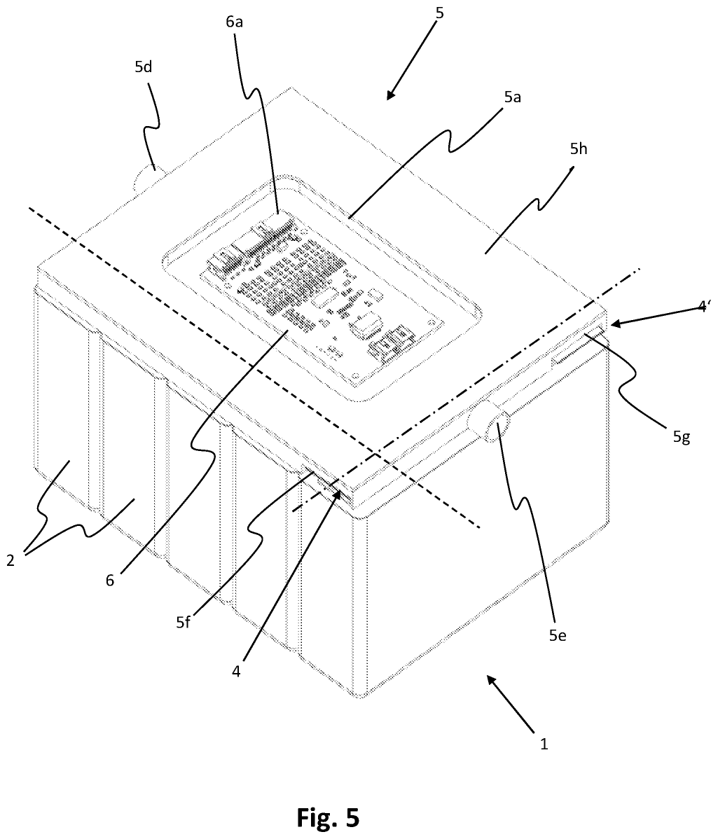

In the introductory part of the description it has already been noted that advantageously—in deviation from the previous figure description—the battery cell connection elements 4, 4′ (cf. FIG. 1) are first arranged in or on the battery cell connection module 5 according to FIG. 5, wherein they are advantageously held in or on the battery cell connection module 5 in a frictionally engaged and/or form-fitting manner, for example by clip connections or the like. Subsequently, the battery cell connection module 5 with the battery cell connection elements 4, 4′ is then fitted onto the battery cell connection assembly 1 or the battery cells 2, as shown in FIG. 4. Suitable fastening structures (not shown) may be provided on the battery cells 2 and cooperate with corresponding, complementary fastening structures (also not shown) on the battery cell connection module 5 to fasten the battery cell connection module 5 to the battery cells 2. The battery cells 2 can also be installed in a (module) housing (not shown) and mechanically prestressed. The fastening structures for mounting the battery cell connection module 5 are then preferably provided on this housing.

Certain details of the battery cell connection module 5 will now be discussed in greater detail:

The battery cell connection module 5 is formed in the manner of a flat frame (as a main body) made of injection-molded plastic, which has a central recess 5a. In this central recess 5a, a PCB (electronic printed circuit board) 6 is arranged, which is equipped with a number of electronic components 6a, only one of which is denoted in FIG. 4 for reasons of clarity. The PCB 6 is not in itself part of the battery cell connection module 5. Around the mentioned central recess 5a, the battery cell connection module 5 has a number of fluid line portions 5b, 5b′ which are also formed as recesses in the battery cell connection module 5. The differences between the various fluid line portions 5b, 5b′ will be discussed in greater detail further below.

Each of the fluid line portions 5b, 5b′ has two end through-openings 5ba, 5bb, one of which functions as a fluid supply line and the other as a fluid discharge line. On its underside, which is not visible in FIG. 4, the battery cell connection module 5 has receptacles for receiving battery cell connection elements 4, 4′ (cf. FIGS. 1 to 3B) in a form-fitting and/or frictionally engaged manner, wherein these receptacles are formed and/or arranged and matched to the dimensions of the battery cell connection elements 4, 4′ in such a way that the through-openings 5ba, 5bb of the battery cell connection module 5 each correspond fluidically with one of the through-openings 4db, 4ed (cf. FIGS. 2 to 3B) of the battery cell connection elements 4. In other words: A distance between adjacent through-openings 5ba, 5bb of two different fluid line portions 5b, 5b′ corresponds precisely to a distance between the two through-openings 4db, 4eb of a battery cell connection element 4 (cf. FIGS. 2 to 3B). The dimensions of the through-openings 5ba, 5bb and the through-openings 4da, 4ea (of the openings 4db, 4eb) are also matched to one another. Said distance may be different depending on whether the battery cell connection element in question is a battery cell connection element 4 with a corrugated region 4c or a battery cell connection element 4′ without a corrugated region (cf. FIG. 1). A peripheral seal 5c is provided at an upper edge of each of the recesses or fluid line portions 5b, 5b′ and may be formed as a separate sealing element or integrally molded on the battery cell connection module 5. Comparable seals (not visible) are found at the bottom of the battery cell connection module 5 in the region of the through-openings 5ba, 5bb, where the battery cell connection module 5 interacts fluidically with the battery cell connection elements 4, 4′.

The fluid line portions 5b′ are longer than the fluid line portions 5b and each have an additional through-opening 5bc, which is fluidically connected to a supply line 5d or to a discharge line 5e for a temperature control fluid. In this way, a temperature control fluid can be supplied to the battery cell connection module 5 and also discharged therefrom. The fluid line portions 5b, 5b′ supplement the battery cell connection elements 4 arranged below the battery cell connection module 5 (cf. FIGS. 1 to 3B) to form a dual-branch flow channel for the temperature control fluid, fluidically connecting the supply line 5d to the discharge line 5e. This is shown schematically in FIG. 4 for one flow branch; cf. the (dashed) arrows. Here, the solid arrows symbolize a flow of the temperature control fluid at the top side of the battery cell connection module 5 through the fluid line portions 5b and 5b′, respectively, while the dashed arrows in FIG. 4 symbolize a flow of the temperature control fluid through an underlying battery cell connection element 4 according to FIGS. 1 to 3B. The temperature control fluid transitions from the fluid line portions 5b, 5b′ to the battery cell connection elements 4 in each case through the corresponding or communicating through-openings, as described further above.

In this way, the cell arresters (not visible in FIG. 4) of the battery cells 2 can be electrically contacted (cf. FIG. 1) on the one hand and efficiently temperature-controlled (cooled) on the other, wherein the temperature control fluid preferably does not follow the same meandering flow path as the current flow S illustrated in FIG. 1.

Since the individual battery cell connection elements 4, 4′ according to FIGS. 1 to 3B do not touch one another and the fluid line portions 5b, 5b′ according to FIG. 4 are formed together with the rest of the battery cell connection module 5 in an electrically non-conductive plastic, there is no electrical short circuit of the battery cell assembly 1 in this way—advantageously not even if no (costly) dielectric is used as the temperature control fluid.

With reference signs 5f and 5g, the battery cell connection module 5 has lateral recesses, through which individual battery cell connection modules 4, 4′ are accessible from the outside. Such battery cell connection modules 4, 4′ can thus be used in a simple manner for electrically contacting the entire battery cell assembly 1.

The black block arrow in FIG. 4 corresponds to the corresponding block arrows in FIG. 3A and is again intended to symbolize the accessibility of the battery cell connection elements 4, 4′ from the outside, i.e. also through the battery cell connection module 5 or the mentioned through-openings 5ba, 5bb. It is possible here, within the scope of the invention, to first arrange the battery cell connection elements 4, 4′ in or on the battery cell connection module 5, to fit the battery cell connection assembly thus created, formed of battery cell connection element 4, 4′ and battery cell connection module 5, onto the battery cells 2 or the battery cell assembly 1, and only at the end to connect the individual battery cell connection elements 4, 4′ to the underlying cell arresters (not shown) of the battery cells 2, as already described in detail further above. This improves the handling and ease of assembly enormously.

In this context, it may also be provided to arrange the PCB 6 in the central recess 5a of the battery cell connection module 5 and to fit it together with the latter onto the battery cell assembly 1. Advantageously, galvanic connections (shown in FIG. 4 at reference 6b by way of example) exist inside the battery cell connection module 5 and can electrically conductively connect the PCB 6 or certain electronic components 6a to the battery cell connection elements 4, 4′ and correspondingly the cell arresters (not shown) of the battery cells 2. In this way, the PCB 6 can be used in particular to implement a battery management system (BMS) without the need for subsequent time-consuming and costly cabling for this purpose.

To prevent the temperature control fluid from escaping from the fluid line portions 5b, 5b′ which are open at the top according to FIG. 4, the battery cell connection module 5 according to FIG. 5 also comprises a cover part 5h, which cover part 5h tightly seals at least the fluid line portions 5b, 5b′, but not the central recess 5a, so that no temperature control fluid can escape from the fluid line portions 5b, 5b′ (cf. FIG. 4). For this purpose, in particular, the aforementioned seals 5c come into contact with the cover part 5h from below. Like the rest of the battery cell connection module 5, the cover part 5h is also preferably made of an electrically non-conductive, injection-moldable plastic.

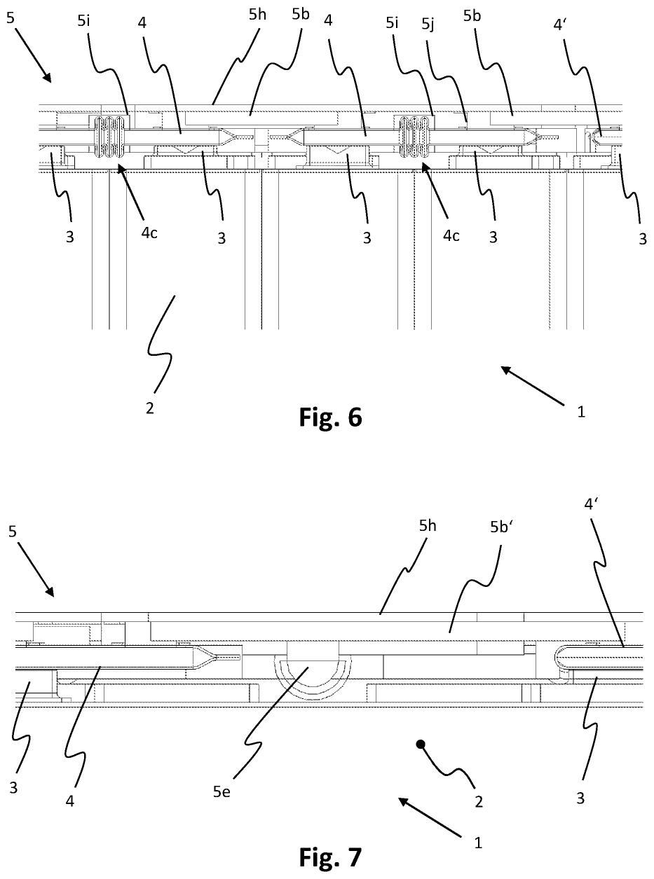

The sectional views shown in FIGS. 6 and 7 below are oriented along the dashed and dash-dotted lines in FIG. 5, respectively. FIG. 6 shows a sectional view roughly along the dashed line in FIG. 5. It is easy to see here how the battery cell connection elements 4 are connected (in an integrally bonded manner) according to FIG. 3A to the underlying cell arresters 3 of the battery cells 2. It is also easy to see how the cover part 5h closes off or seals the individual fluid line portions 5b at the top. Reference sign 5i denotes the receptacles for the battery cell connection elements 4 already mentioned, in particular in the region of the corrugated portions 4c. Reference sign 5j denotes hold-down elements, which may be intended to bring the battery cell connection elements 4 into defined contact with the cell arresters 3 before an integrally bonded connection of the battery cell connection elements 4 to the cell arresters 3 is established. In certain embodiments, such an integrally bonded connection may even be dispensable under certain circumstances if the battery cell connection module 5 already ensures a sufficiently firm, permanent fixing of the battery cell connection elements 4 to the cell arresters 3.

FIG. 7 shows a corresponding sectional view approximately along the dash-dotted line in FIG. 5. In particular, the discharge line for the temperature control fluid can be seen here, cf. reference sign 5e according to FIGS. 4 and 5.

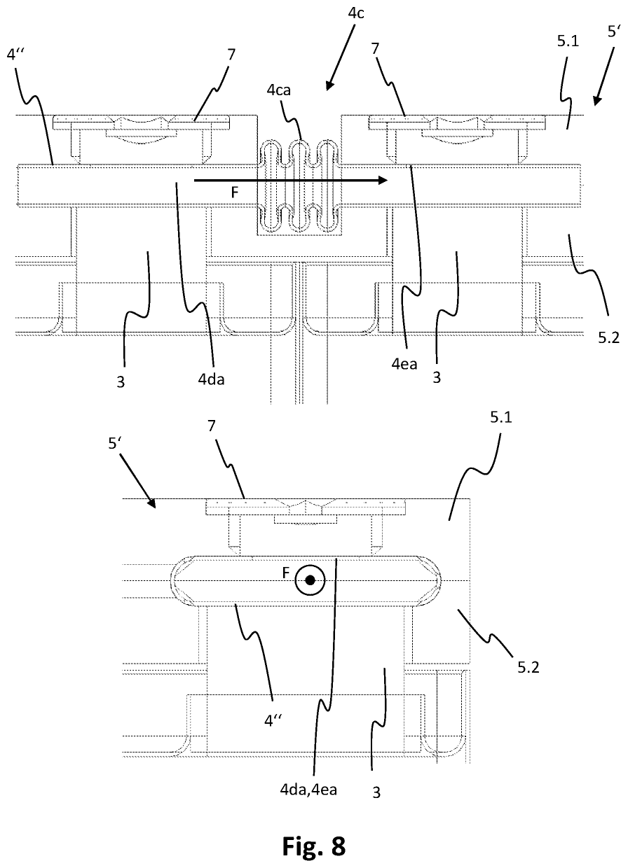

FIG. 8, top image, shows an alternative battery cell connection element 4″ with open ends in longitudinal section. The associated battery cell connection module 5′ has two (plastic) half-shells 5.1 (upper shell) and 5.2 (lower shell), i.e., it is made in two parts. The temperature control fluid then flows through the assembly in the direction of the longitudinal axis, i.e. parallel to the drawing plane (arrow F). The cross-section is shown in the bottom image. The battery cell connection elements 4″ are located in the sandwich between upper shell 5.1 and lower shell 5.2. For the tool for connecting the battery cell arresters, through-openings 4da, 4ea can still be present between the region 4c and the half-shells 5.1, 5.2, but are closed off after assembly (by stoppers or the like made of an elastic material, reference sign 7).

A variant without through-openings is also possible; in this case, the battery cell arresters can be connected laterally by means of a fillet weld.

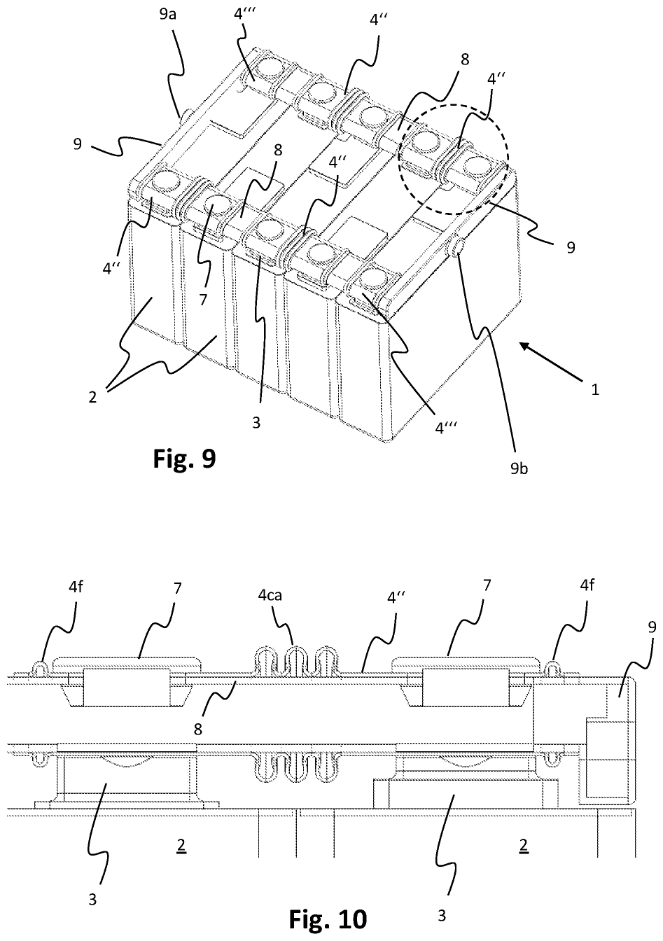

FIG. 9 shows a perspective view of another embodiment of the battery cell assembly 1 with a number of battery cell connection elements 4″, which are substantially as shown in FIG. 8. Reference signs 4″ show shortened (halved) variants of these connection elements (without bellows corrugations), each of which covers only one arrester 3. On both sides of the assembly 1, the connection elements 4″, 4′″ are connected fluidically, in which an electrically insulating line element 8 made of plastic is passed through all the connection elements 4″, 4′″ concerned. The free ends of the line elements 8 open out at the end faces of the assembly 1 into a collector element 9 with supply line 9a or discharge line 9b (cf. FIGS. 4 and 5, reference signs 5d, 5e there). Preferably, the connection elements 4″, 4′″ are first attached (welded on), as previously described, and then lined with the line elements 8. Lastly, the collection elements 9 are attached. Corresponding through-openings in the connection elements 4″, 4′″ (cf. FIG. 8) and in the line elements are closed jointly with stoppers 7, cf. also FIGS. 10 to 12.

FIG. 10 shows a longitudinal section through the assembly 1 according to FIG. 9, approximately in the region of the circle shown in FIG. 9 by a dashed line. Newly denoted in FIG. 10 are adhesive corrugations 4f, which run around the end of the connection element 4″ and which are filled with an adhesive and sealing agent (not shown) in order to connect the line element 8 fluid-tightly and in an integrally bonded manner to the connection element 4″.

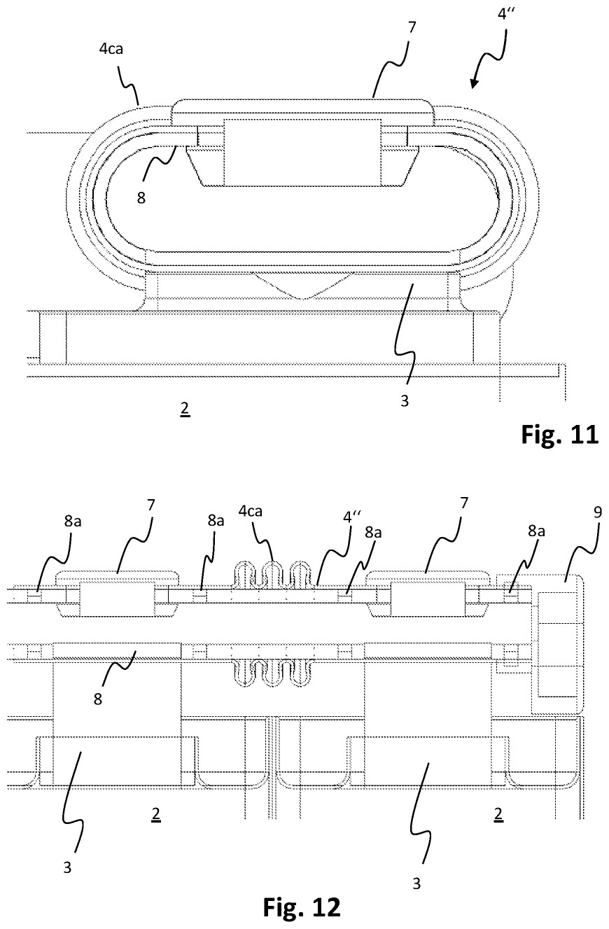

FIG. 11 shows a cross-section through the connection element 4″ approximately in the same region.

FIG. 12 shows an alternative embodiment, wherein the illustration corresponds to that of FIG. 10. However, in FIG. 12 the connection element 4″ does not have adhesive corrugations, but instead peripheral adhesive grooves or channels 8a are arranged on the line element 8 and serve for the same purpose.

1. A battery cell connection element (4, 4′) comprising:
a main body (44) formed as a fluid line element made of an electrically conductive material with a longitudinal axis (L), said main body (44) being closed at two ends (4a, 4b) thereof, in particular fluid tightly, and has a peripherally substantially closed casing wall; and at least two through-openings (4da, 4ea) are arranged on a same side of the main body (44), said through-openings (4da, 4ea) being arranged next to one another and offset in a direction of the longitudinal axis (L).

2. The battery cell connection element (4, 4′) as claimed in claim 1, wherein the main body (44) is substantially planar in portions, at least on a side opposite the through-openings (4da, 4ea), so that the substantially planar portions (4d′, 4e′) of the main body (44) are aligned with the through-openings (4da, 4ea) in a direction transverse to the longitudinal axis (L).

3. The battery cell connection element (4, 4′) as claimed in claim 1, wherein the main body (44), except at the ends (4a, 4b), has an oval cross-section.

4. The battery cell connection element (4, 4′) as claimed in claim 1, wherein the main body (44) is at least one of flattened or folded at the two ends (4a, 4b) and thus closed.

5. The battery cell connection element (4, 4′) as claimed in claim 1, wherein the main body (44) has two substantially identical halves along the longitudinal axis (L), between which a central portion (4c) of modified shape is arranged, which said central portion (4c) has at least one peripheral bellows corrugation (4ca) formed integrally with a remainder of the main body (44).

6. The battery cell connection element (4, 4′) as claimed in claim 1, wherein the through-openings (4da, 4ea) have a clear opening cross-section (4db, 4eb) suitable for insertion of a tool.

7. A battery cell connection module (5) comprising:
at least two receptacles (5i), each configured to receive with at least one of a form-fit or frictional engagement a battery cell connection element (4, 4′) that has a main body (44) formed as a fluid line element made of an electrically conductive material with a longitudinal axis (L), which said main body (44) is closed at two ends (4a, 4b) thereof;
a fluid line portion (5b, 5b′) having a fluid supply line (5ba) and a fluid discharge line (5bb), in which at least the fluid line portion (5b, 5b′) is formed in an electrically non-conductive material and in which the fluid supply line (5ba) and the fluid discharge line (5bb) are arranged relative to the receptacles (5i) such that the fluid supply line (5ba) is in fluidic connection with one said receptacle (5i) and the fluid discharge line (5bb) is in fluidic connection with an other said receptacle (5i).

8. The battery cell connection module (5) as claimed in claim 7, comprising a first number of more than two of said receptacles (5i) and comprising a second number of more than one said fluid line portion (5b, 5b′), in which each said fluid line portion (5b, 5b′) always connects at least two said receptacles (5i) fluidically.

9. The battery cell connection module (5) as claimed in claim 8, wherein at least one of the fluid line portions (5b, 5b′) or the receptacles (5i) each run in or parallel to a common plane and/or are arranged distributed over a periphery of a rectangle.

10. The battery cell connection module (5) as claimed in claim 8, wherein a first said fluid line portion (5b′) has a supply line (5d) for a temperature control fluid to the first fluid line portion (5b′) and a second said fluid line portion (5b′) has a discharge line (5e) for a temperature control fluid from the second fluid line portion (5b′).

11. The battery cell connection module (5) as claimed in claim 7, wherein the fluid line portion (5b, 5b′) or the fluid line portions (5b, 5b′) are open on a first side of the battery cell connection module (5) and the receptacles (5i) are arranged on a second side of the battery cell connection module (5) facing away from the first side.

12. The battery cell connection module (5) as claimed in claim 11, further comprising at least one cover part (5h) that seals the at least one fluid line portion (5b, 5b′) from outside fluid-tightly, and the cover part is connected to the battery cell connection module (5) via a living hinge.

13. The battery cell connection module (5) as claimed in claim 9, further comprising a further receptacle (5a) for receiving an electronic printed circuit board (6), said further receptacle (5a) being surrounded by the receptacles (5i) for the battery cell connection elements (4, 4′) and by the fluid line portions (5b, 5b′).

14. The battery cell connection module (5) as claimed in claim 13, further comprising galvanic connections (6b) extending from the further receptacle (5a) to the receptacles (5i) for the battery cell connection elements (4, 4′), said galvanic connections (6b) being formed by conductive tracks onto the battery cell connection module (5).

15. A battery cell connection assembly comprising:
at least first and second ones of the battery cell connection elements (4, 4′) as claimed in claim 1;
at least one battery cell connection module (5) including at least two receptacles (5i), each configured to receive with at least one of a form-fit or frictional engagement the battery cell connection element (4, 4′), and including a fluid line portion (5b, 5b′) having a fluid supply line (5ba) and a fluid discharge line (5bb), in which at least the fluid line portion (5b, 5b′) is formed in an electrically non-conductive material and in which the fluid supply line (5ba) and the fluid discharge line (5bb) are arranged relative to the receptacles (5i) such that the fluid supply line (5ba) is in fluidic connection with one said receptacle (5i) and the fluid discharge line (5bb) is in fluidic connection with an other said receptacle (5i);
wherein the first battery cell connection element (4, 4′) and the second battery cell connection element (4, 4′) are each arranged in a corresponding said receptacle (5i), such that the first battery cell connection element (4, 4′) via one of said through-openings (4da, 4ea) is in fluidic connection with the fluid supply line (5ba) and the fluid discharge line (5bb) is in fluidic connection with one of the through-openings (4da, 4ea) of the second battery cell connection element (4, 4′), or so that the two battery cell connection elements (4, 4′) are in fluidic connection with one another via one of the through-openings (4da, 4ea) and via the fluid line portion (5b, 5b′), and the two battery cell connection elements (4, 4′) are spaced apart from one another.

16. The battery cell connection assembly as claimed in claim 15, wherein the battery cell connection elements (4, 4′) and the fluid line portions (5b, 5b′) jointly form a closed fluid circuit.

17. The battery cell connection assembly as claimed in claim 15, wherein the battery cell connection elements (4, 4′) are accessible from the first side via the fluid supply line (5ba) or the fluid discharge line (5bb) and from outside via the respective through-openings (4da, 4ea).

18. The battery cell connection assembly as claimed in claim 15, further comprising an electronic printed circuit board (6) received in a further receptacle (5a) of the battery cell connection module (5), said electronic printed circuit board (6) comprises electronic components (6a) configured for controlling an operation of a battery cell assembly (1) formed of a plurality of battery cells (2).

19. The battery cell connection assembly as claimed in claim 18, wherein at least one of the electronic printed circuit board (6) or at least some electronic components (6a) electrically contact the battery cell connection elements (4, 4′) via the galvanic connections (6b).

20. The battery cell connection assembly as claimed in claim 15, wherein the battery cell connection elements (4, 4′) are held with a form-fit or frictional engagement on the battery cell connection module (5) in a region of the receptacles (5i).

21. A battery cell assembly (1) comprising:
a plurality of battery cells (2);
a battery cell connection assembly as claimed in claim 15;
wherein the individual battery cells (2) each have a first cell arrester (3) with a first electrical polarity and a second cell arrester (3) with a second electrical polarity, the first cell arrester (3) of one said battery cell (2) is electrically conductively connected to the second cell arrester (3) of another said battery cell (2) via the battery cell connection element (4), the first battery cell connection element (4) is fluidically connected to the second battery cell connection element (4) via the fluid line portion (5b).

22. The battery cell assembly (1) as claimed in claim 21, wherein the battery cell connection elements (4, 4′) are connected to the cell arresters (3) in an integrally bonded manner.

23. The battery cell assembly (1) as claimed in claim 21, wherein the battery cell connection elements (4, 4′) and the fluid line portion (5b, 5b′) or the fluid line portions (5b, 5b′) are filled with a temperature control fluid or are passed through by a temperature control fluid.

24. A method for controlling a temperature of and electrically contacting battery cells (2) of a battery cell assembly (1) as claimed in claim 21, the method comprising:
a) providing the battery cell connection elements (4, 4′);
b) providing the battery cell connection module (5);
c) arranging the battery cell connection elements (4, 4′) in the battery cell connection module (5) to create the battery cell connection assembly;
d) producing the battery cell assembly (1) by attaching the battery cell connection assembly to an assembly of said battery cells (2) and electrically conductively connecting the battery cell connection elements (4, 4′) to the cell arresters (3);
e) passing a temperature control fluid through the battery cell connection elements (4, 4′) and the fluid line portion (5b, 5b′) or fluid line portions (5b, 5b′); and
f) electrically contacting the battery cells (2) via the battery cell connection elements (4, 4′).

25. The method as claimed in claim 24, wherein in step d) the battery cell connection elements (4, 4′) are connected to the cell arresters (3) from outside through the fluid supply line (5ba) or the fluid discharge line (5bb) and via the respective through-openings (4da, 4ea), and subsequently, before step e), fitting a cover part (5h) to close off the battery cell connection assembly.
